(19) United States
(12) Patent Application Publication
(10) Pub. No.: US 2016/0260189 A9
(43) Pub. Date: Sep. 8, 2016

(54) Reverse Provider Practice

(71) Applicant: Roy Schoenberg, Boston, MA (US)

(72) Inventor: Roy Schoenberg, Boston, MA (US)

(73) Assignee: AMERICAN WELL CORPORATION, Boston, MA (US)

(21) Appl. No.: 13/465,528

(22) Filed: May 7, 2012

Related U.S. Application Data
(63) Continuation-in-part of application No. 12/264,524, filed on Nov. 4, 2008, now Pat. No. 8,738,727.
Application No. 12/264,524 is a continuation of application No. 11/763,680, filed on Jun. 15, 2007, now Pat. No. 7,590,550.
(60) Provisional application No. 61/482,982, filed on May 5, 2011.
(60) Provisional application No. 60/824,966, filed on Sep. 8, 2006.
(60) Provisional application No. 60/828,921, filed on Oct. 10, 2006.
(60) Provisional application No. 60/828,924, filed on Oct. 10, 2006.
(60) Provisional application No. 60/829,139, filed on Oct. 11, 2006.
(60) Provisional application No. 60/829,140, filed on Oct. 11, 2006.

(51) Int. Cl. G06Q 50/22; G06F 19/00

(52) U.S. Cl. CPC G06Q 50/22; G06F 19/328

(57) ABSTRACT

A computer-implemented method includes receiving, by one or more computer systems, a request sent from a computing device used by a consumer, the request being to find a service provider; determining whether the consumer that sent the request is associated with a sponsor; when associated with a sponsor, retrieving, by the one or more computer systems, a listing of types of services offered by the sponsor; sending, by the one or more computer systems to the computing device, a list of one or more qualified service providers that are qualified to provide a type of service selected from the listing; receiving, by the one or more computer systems, a selection of a service provider from the list; and establishing a communication channel between the computing device used by the consumer and a computing device used by the selected service provider.

### CLAIM OF PRIORITY

This application claims priority under 35 U.S.C. §119(e) to provisional U.S. Patent Application 61/482,982, filed on May 5, 2011, the entire contents of which are hereby incorporated by reference.

### BACKGROUND

Systems have been developed to provide services that connect consumers and their providers over the Internet and the World Wide Web. Some systems use e-mail messaging and web-based forms to increase the level of connectivity between a member of a health plan and his assigned health care provider. The consumer sends an e-mail or goes to a website that generates and sends a message (typically an e-mail or an e-mail type message) to a local provider.

These types of services have been broadly referred to as “e-visits.” While generally viewed as an addition to the spectrum of services that may be desired by consumers, the benefits of such services are not clear. One of the concerns associated with offering additional communication channels, such as e-mail, is that it can result in over consumption of services, rather than provide for better coordination.

Another system is a brokerage type of system as described in my issued Patent U.S. Pat. No. 7,590.550, which is incorporated herein by reference.

### SUMMARY

In one aspect of the present disclosure, a computer-implemented method includes receiving, by one or more computer systems, a request sent from a computing device used by a consumer, the request being to find a service provider; determining whether the consumer that sent the request is associated with a sponsor; when associated with a sponsor, retrieving, by the one or more computer systems, a listing of types of services offered by the sponsor; sending, by the one or more computer systems to the computing device, a list of one or more qualified service providers that are qualified to provide a type of service selected from the listing; receiving, by the one or more computer systems, a selection of a Service provider from the list; and establishing a communication channel between the computing device used by the consumer and a computing device used by the selected service provider.

Implementations of the disclosure can include one or more of the following features. In some implementations, the method also includes identifying, by the one or more computer systems, at least one of the one or more qualified service providers as being presently available to engage in a consultation with the consumer. In other implementations, the method includes generating a graphical user interface to send to the computing device used by the consumer, the graphical user interface rendering the listing of types of services.

In other implementations, the method includes receiving information indicative of a change in the types of services offered by the sponsor. In yet other implementations, the method includes tracking selections of the types of services offered; analyzing tracked selections of the types of services offered providing statistical analysis of the selections by consumers; and modifying the types of services offered based on the statistical analysis made of the selections. In some implementations, the method includes receiving, from the computing device used by the consumer, a selection of one of the types of services; and causing the graphical user interface to be updated with visual representations of the one or more service providers qualified to provide the selected type of service. In still other implementations, one or more of the visual representations are juxtaposed to one or more status indicators indicative of a status of a service provider.

In still another aspect of the disclosure, one or more machine-readable media are configured to store instructions that arc executable by one or more processing devices to perform operations including receiving a request sent from a computing device used by a consumer, the request being to find a service provider; determining whether the consumer that sent the request is associated with a sponsor; when associated with a sponsor, retrieving a listing of types of services offered by the sponsor; sending, to the computing device, a list of one or more qualified service providers that are qualified to provide a type of service selected from the listing; receiving a selection of a service provider from the list; and establishing a communication channel between the computing device used by the consumer and a computing device used by the selected service provider. Implementations of this aspect of the present disclosure can include one or more of the foregoing features.

In still another aspect of the disclosure, an electronic system includes one or more processing devices; and one or more machine-readable media configured to store instructions that are executable by the one or more processing devices to perform operations including: receiving a request sent from a computing device used by a consumer, the request being to find a service provider; determining whether the consumer that sent the request is associated with a sponsor; when associated with a sponsor, retrieving a listing Of types of services offered by the sponsor; sending, to the computing device, a list of one or more qualified service providers that are qualified to provide a type of service selected from the listing; receiving a selection of a service provider from the list; and establishing a communication channel between the computing device used by the consumer and a computing device used by the selected service provider. Implementations of this aspect of the present disclosure can include one or more of the foregoing features.

All or part of the foregoing can be implemented as a computer program product including instructions that are stored on one or more non-transitory machine-readable storage. media, and that are executable on one or more processing devices. All or part of the foregoing can be implemented as an apparatus, method, or electronic system that can include one or more processing devices and memory to store executable instructions to implement the stated functions.

The details of one or more implementations are set forth in the accompanying drawings and the description below. Other features, objects, and advantages will be apparent from the description and drawings, and from the claims.

### BRIEF DESCRIPTION OF THE FIGURES

FIG. 1 is a diagrammatic view of a system for a reverse provider practice.

FIGS. 2-4 and 6 are flow charts of processes used in a reverse provider practice.

FIG. 5 is a screenshot of a reverse provider practice graphical user interface.

FIG. 7 is a block diagram of a computer (computer system) showing exemplary components that can be used for the brokerage system and/or client systems.

### DETAILED DESCRIPTION

The system described below provides an integrated information and communication platform that enables a sponsor to restrict selection of services and service providers for consumers that have an association with the sponsor. The sponsor selects a subset of services and service providers that are brokered and available through the system. From the sponsor selection of services and service providers, the brokerage identifies and prioritizes those service providers presently available for a consultation (e.g., via live video and/or live audio and/or the telephone and/or live chat and/or via secure message) with the consumer.

Through the system, dynamic populations (e.g., consumers and service providers) engage in interactions at times that are convenient for the consumers and the service providers, because the system matches real-time availability Of the service providers with consumers' real-time requests to engage with the service providers. Consumers at clients systems 122 are able to interact on-line with a service provider, even when the two parties are geographically separated. This integrated platform is referred to herein as an engagement brokerage service (brokerage).

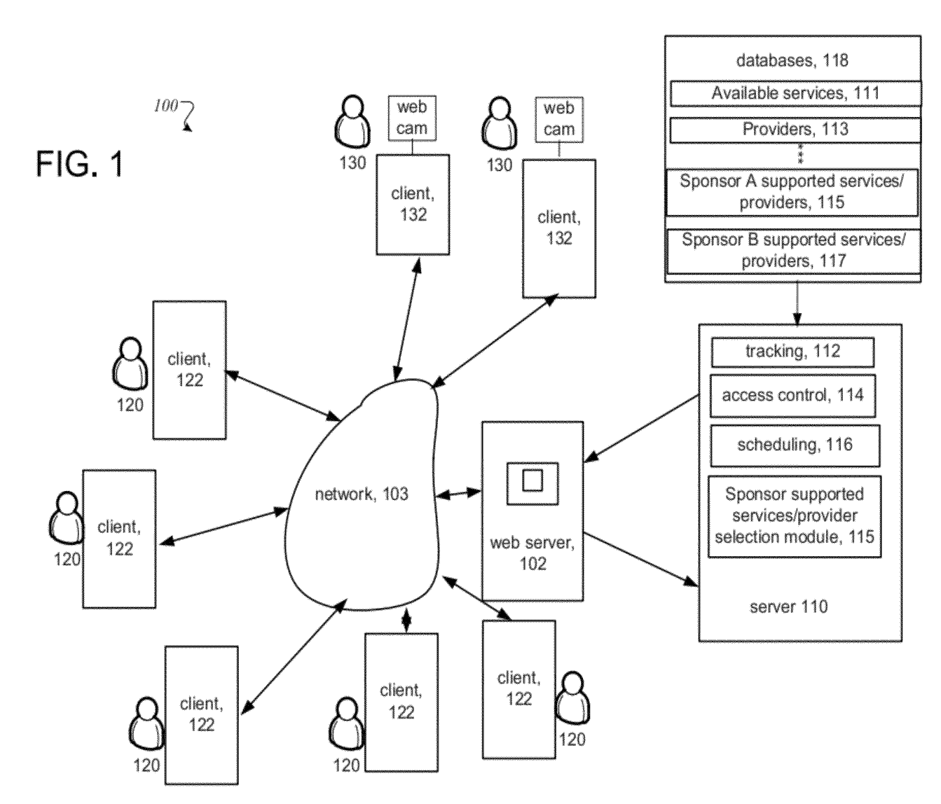

FIG. 1 shows an example system 100 implementing the brokerage service for a reverse provider practice. The system 100 includes a computerized system or server 110 for making connections between consumers 120, at client systems 122, and service providers 130, at client systems 132 including, e.g., web cams or the like over a network 103, e.g., the Internet or other types of networks. The computerized system 110 operates as a service running on a web server 102.

The computerized system 110 includes an availability or presence tracking module 112 for tracking the availability of the service providers 130. Availability or presence is tracked actively or passively. In an active system, one or more of the service providers 130 provides an indication to the computerized system 110 that the one or more service providers are available to be contacted by consumers 120 and an indication of the mode by which the provider is contacted. In some examples of an active system, the provider's computer, phone, or other terminal device periodically provides an indication of the provider's availability (e.g., available, online, idle, busy) to the system 110 and a mode (e.g., text, voice, video, etc.) by which he can be engaged. In a passive system, the computerized system 110 presumes that the service provider 130 is available by the service provider's actions, including connecting to the computerized system 110 or registering the provider's local phone number with the system. In some examples of a passive system, the system 110 indicates the provider 130 to be available at all times until the provider logs off, except when the provider is actively engaged with a consumer 120.

The computerized system 110 also includes one or more processes such as the tracking module 112 and a scheduling module 116. The system 110 accesses one or more databases 118. The components of the system 110 and the web server 102 may be integrated or distributed in various combinations as is commonly known in the art. The database 118 includes information 111 regarding available services generally covered by the brokerage system 100, information 113 regarding providers engaged with the brokerage system 100. The database 118 also includes sponsor supported services/providers listings such as diagrammatically shown as “Sponsor A supported services/providers, 115” and “Sponsor B supported services/providers, 117.” These sponsor supported services/providers listings can be represented in various ways and structures in the database 118. For example, such listings can be listings or files in the database or can be dynamically generated based on values of fields included with individual records of providers and services in the database. The server 110 also includes sponsor supported services/provider selection module 115 that runs on the server 110, as will be further discussed below.

Using the system 100, a consumer 120 communicates with a provider 130 that the consumer selects from the chosen set of providers and/or services. The consumer 120 and provider 130 are connected to the computerized system 110 through a website or other interface on the web server 102 using client devices 122 and 132, respectively. Client devices 122 and 132 can be any combination of, e.g., personal digital assistants, land-line telephones, cell phones, computer systems, media-player-type devices, and so forth. The client devices 122 and 132 enable the consumers 120 to input and receive information as well as to communicate via video, audio, and/or text with the providers 130.

System 100 implements a reverse provider practice. In a reverse provider practice, a sponsor (e.g., an employer) chooses the services and the service providers to offer the chosen services to its employees (or other individuals covered through the sponsor's plan, also sometimes referred to herein as “consumers.” In an example, the reverse provider practice enables a sponsor to swap-out services that are offered to consumers 120 (e.g., employees). In the reverse provider practice, the pool of consumers, basket of services and the pool of providers periodically change, e.g., with changes to the population of employees of the sponsor and as a sponsor changes the services and providers that arc offered to consumers.

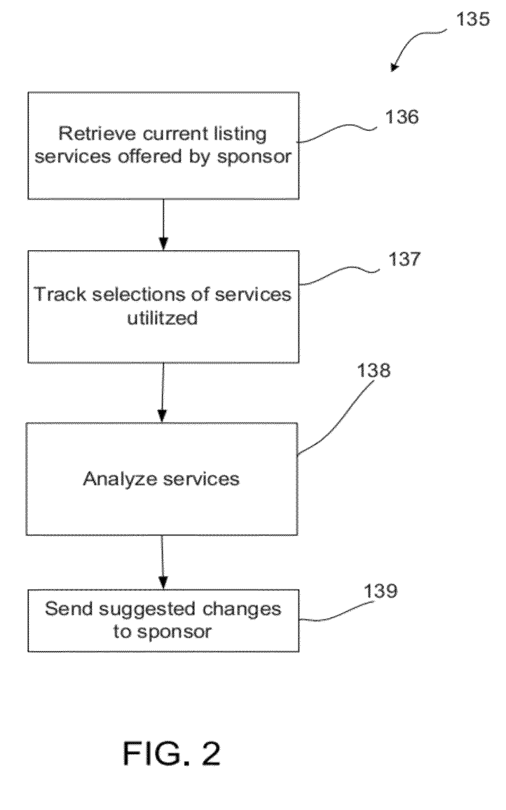

Referring now to FIG. 2, the server 110 executes process 135, in which the sponsor chooses the offered service providers based on any of a variety of factors. In this example, the server 110 retrieves (136) a current listing of services offered by a sponsor. For example, information 115, 117 includes a current listing of services for different sponsors, namely, sponsors A and B.

A sponsor selects offered services based on usage data. Usage data is indicative of an amount of health services being consumed, by consumers, for a particular type of health service.

To generate usage data, the server 11 tracks (137) the selections made by insured participants of potential health services offered by the sponsor of a health insurance plan, e.g., an employer or a governmental body or entity. The server 110 and/or a sponsor computer system (e.g., client 122) analyzes (138) the selections of the health services offered to participants to provide usage data and various statistical analysis of these selections made by employees. Based on this analysis, the server 110 sends (139) to a computing device of the sponsor one or more suggested changes to the services and/or types of services offered by the sponsor. The server 110 and/or the sponsor system causes a modification of types of health services offered. The analysis considers various factors, such as the gender, age, health status of the insured, as well as the availability of the services, cost of the services and how often the services were selected by segments of insured groups of individuals.

The server 110 determines the types of health services that are frequently used and/or consumed by participants, e.g., employees, consumers, and so forth. The server 110 collects statistics indicative of an absolute number of services that have been consumed, for example, by tracking a number of requests from employees for particular medical services.

An employer elects to make the following services available to employees: chiropractic services, dietary and nutrition services, and physical therapy services. The server 110 tracks a number of employees that request consultations with service providers that provide these services. For example, the server 110 collects information indicating that twenty employees have consumed the chiropractic services and fifteen employees have consumed the dietary and nutrition services.

The server 110 determines that no employees have requested consultations with the service providers providing the physical therapy services. Accordingly, the server 110 generates statistical information (e.g., in a report) that includes visual indicators of the heavy usage of the chiropractic services, the moderate usage of the dietary and nutrition services, and the low usage of the physical therapy services. Based on this usage information, an employer decides to provide its employees with a different selection of offered services. For example, the employer decides to remove the physical therapy services from the list of offered services. The employer decides to replace the service offering for physical therapy services with a service that the employer anticipates will be more frequently used by its employees.

The server 110 also generates suggested service offerings, e.g., based on the usage data that are collected for the employer, based on a business field of the employer, and/or based on usage data that are collected across all employers that provide service offerings. The server 110 uses. the usage data to determine that the chiropractic services and the dietary and nutrition services are most frequently used by the employees. The server 110 selects suggested service offerings that are related to chiropractic services and/or dietary and nutrition services.

The server 110 collects statistical usage information for various types of sponsors (e.g., employers) of offered services. Based on the collected statistical usage information, the server 110 determines categories and/or types and/or particular services that are heavily used and/or are used by consumers (e.g., employees) a number of times that exceeds a threshold value. The most frequently used services are presented to an employer that is trying to make a determination about what services to offer its employees.

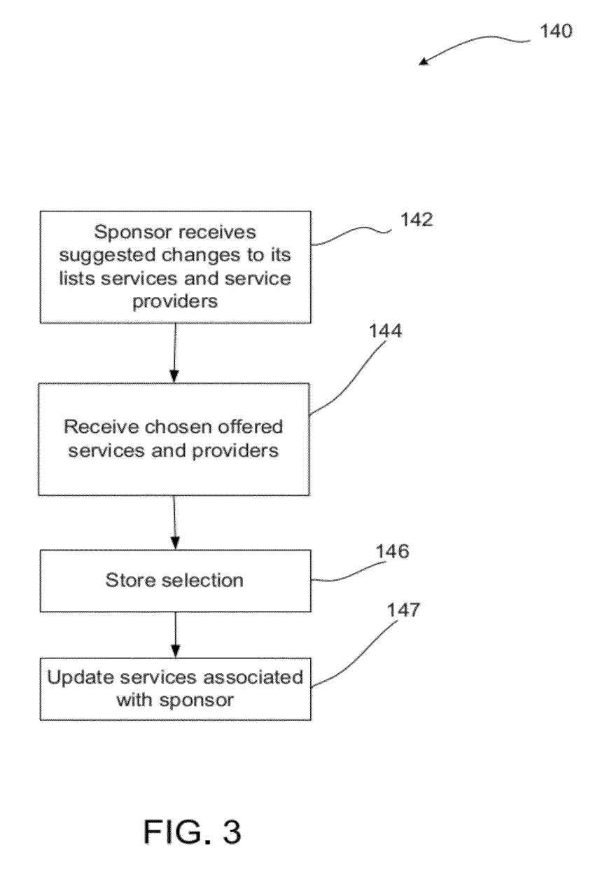

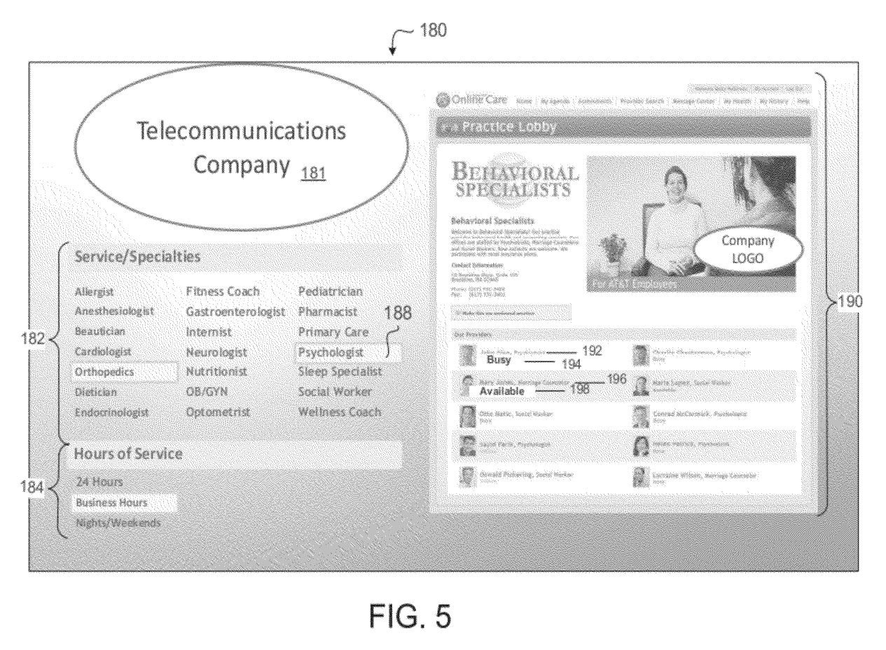

Referring to FIG. 3, server 110 executes process 140 in the reverse provider practice. In operation, the server 110 generates a graphical user interface (not shown) that displays, for the sponsor, the various types of health services 111 and the various types of providers 113 that may be offered to a consumer 120. The various types of health services, include, e.g., the types of health services shown in portion 182 (FIG. 5) of graphical user interface 180. The graphical user interface may also display, for each type of health service, usage data to indicate an estimated amount of usage by consumers for the particular type of health service. The brokerage system sends (142) the graphical user interface, to a device used by sponsor. with the interlace listing various types of services and/or service providers that the sponsor may offer to consumers 120.

In response to a sponsor making a selection of types of services and/or service providers, the server 110 receives (144) a selection of offered service providers and/or offered types of services. Server 110 stores (146) the selection in database 118.

Using the selection, server 110 generates information 115, 117. For example, sponsor A makes a selection, from the sent interface, of types of services and/or service providers to be offered by sponsor A. Using the selection from sponsor A, server 110 stores the selection as information 115 in database 118.

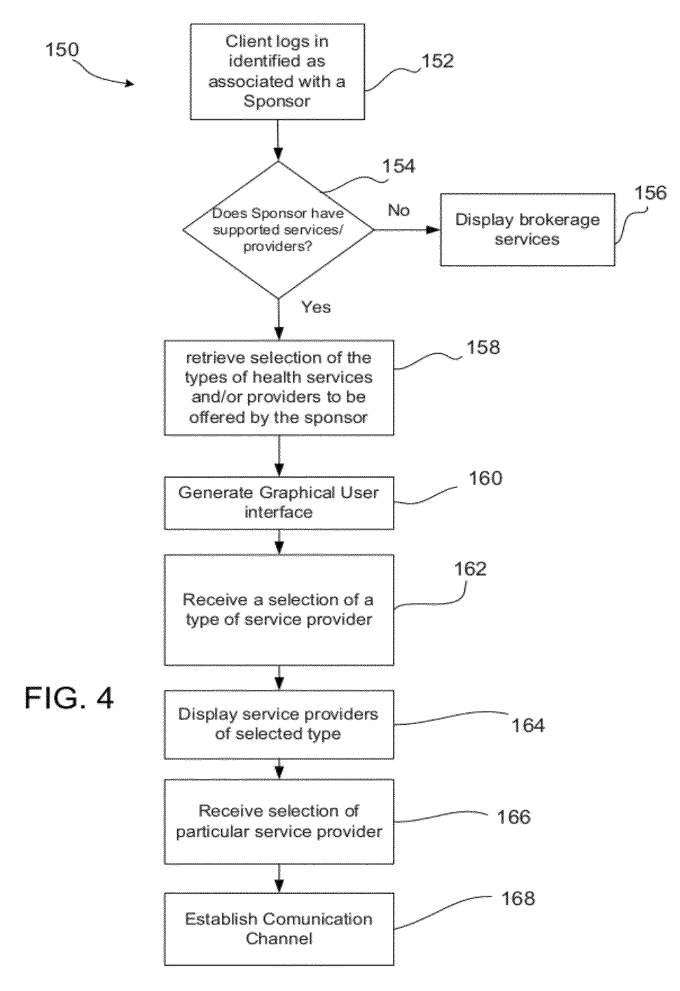

Referring to FIG. 4, server 110 also executes process 150 in implementing a reverse provider practice. In operation, server 110 receives (152), from client device 122 of consumer 120, information specifying that a client has logged into server 110 and is identified as being associated with a sponsor. In an example, the consumer logs in and server 110 identifies one or more sponsors that are associated with the consumer.

In response, server 110 determines (154) whether the sponsor associated with the consumer 120 has offered types of services and/or service providers. If the server 110 determines that the sponsor does not have offered types of services and/or service providers, the server 110 causes (156) information indicative of other brokerage services to be sent to client device 122. For example, a brokerage service as described in U.S. Pat. No. 7,590,550 could be used.

If the server 110 determines that the sponsor does offer types of services and/or service providers, the server 110 retrieves (158), from database 118, a selection of the types of health services and/or providers to be offered by the sponsor. As described below it is assumed that the reverse provided practice is based on selection of services offered. However, the reverse provided practice could alternatively be based on selection of service providers offered.

Using the selection of types of health services offered by the sponsor, server 110 generates (160) graphical user interface 180 (FIG. 5) for rendering on client devices 122. Server 110 receives (162), from client device 122 used by an employee, a selection of a particular type of health service. For example, a consumer 122 selects visual representation 188 (FIG. 5) in graphical user interface 180 to request to view service providers (e.g., psychologists) that are associated with a particular type of health service.

In response to the request, the server 110 displays (164) in graphical user interface 180 portion 190 (FIG. 5), that when rendered on client device 122 displays visual representations 192, 196 (FIG. 5) with names of service providers that are juxtaposed to status indicators 194, 198. Using client device 122, a consumer makes a selection of a service provider for a consultation, e.g., by selecting one of visual representations 192, 196 and/or status indicators 194, 198. In response to the selection, the server 110 receives (166) the selection of the particular service provider, e.g., a selection of the service provider associated with visual representation 196 (FIG. 5). The server 110 establishes (168) a communication channel between the client device 132 used by the selected service provider and the client device 122 used by the consumer 122.

Referring to FIG. 5, the server 110 generates graphical user interface 180 for a reverse provider practice. Graphical user interface 180 displays the types of health services that are offered by the sponsor to consumers 120 (e.g., employees). The graphical user interface 180, when rendered on a display device (e.g., client device 122), includes portion 182, which depicts visual representations of the types of services that arc being offered by the provider and/or by the sponsor. The graphical user interface 182 is branded with logo 181 of the sponsor. Through the graphical user interface 180, employees view the types of services that are being offered and also request consultations (e.g., in real-time) with service providers that are providing the offered services.

Portion 182 of graphical user interface 180 includes visual representation 188 for a particular type of health service (e.g., psychologists). Visual representation 188 includes a link, which when selected by consumer 120 causes graphical user interface 180 to be updated with portion 190. Portion 190 includes a virtual lobby for service providers of the type that is associated with visual representation 188. Portion 190. lists names of service providers that are of the selected type of health service. Portion 190 includes visual representations 192, 196 or names of service providers of the selected type. Visual representations 192, 196 are associated with status indicators 194, 196. Status indicator 194 specifies that service provider 192 is busy. When service provider 192 is busy, selection of status indicator 194 places consumer 120 in a virtual waiting room for service provider 192. Status indicator 198 specifies that service provider 196 is available for a consultation with consumer 120.

Service provider 196 uses client device 132, and consumer 120 uses client device 122. Status indicator 198 includes a link (or other selectable portion), which when selected by consumer 120 causes a communication channel to be established between client devices 122. 132. The communication channel is established between client device 122. 132 through the server 110 via network 103.

Graphical user interface 180 also includes portion 184 through which consumer 120 specifies service hours for service providers of a selected type. For example, consumer 120 requests to view services providers of the type associated with visual representation 188 and that are available during business hours, nights/weekend, 24 hours a day, etc.

As indicated in portion 182 of graphical user interface 180, a sponsor selects particular types of health service to be offered to consumers 120. The sponsor makes the selection through use of a client device (e.g., client device 122). Based on usage data, the sponsor adjusts the types of health services that are offered to employees. The sponsor makes the adjustment by sending a request to server 110 specifying new types of health services (and/or service provider) to be added to the offered types of health service. The request also includes information specifying types of health services and/or service providers to be removed from the offered service providers. Graphical user interface 180 is a graphical user interface that is dedicated to a particular sponsor. The server 110 generates other graphical user interfaces (not shown) for other, different sponsors.

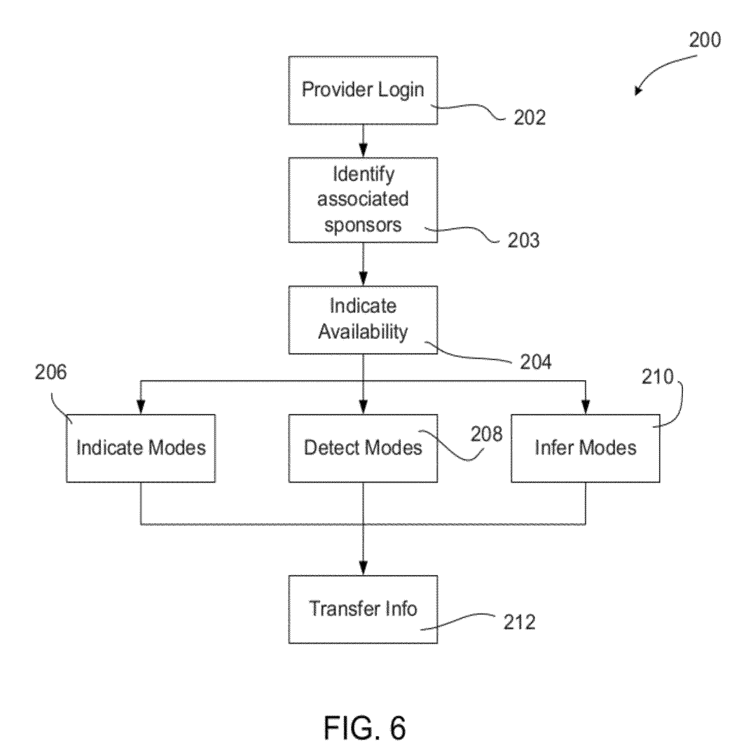

Referring now to FIG. 6, the computerized system 110 tracks 200 the availability of providers 130 that are associated with types of services offered by sponsors. A provider 130 logs (202) into the system 100. The provider 130 identifies (203) associated sponsors of the provider. The provider 130 specifies, via information sent to server 110, whether the provider is associated with sponsor A or with sponsor B. The server 110 uses this information in updating information 115 or information 117, e.g., with new information specifying that the provider 130 is associated with one of sponsors A, B.

The provider 130 indicates (204) (such as by setting a check box or selecting a menu entry or by responding to a voice prompt) to the tracking module 112 that he or she is available to interact with consumers 120 and to broadcast his or her live video and/or audio. The sponsor supported services/provider selection process module 113 uses the availability information in updating information 115, 117. Information 115, 117 also includes information indicative of availability of the providers that are being offered by sponsors.

The provider 130 can also indicate (206) to the tracking module 112 (such as by setting a check box or selecting a menu entry or by responding to a voice prompt) the modes (e.g., telephone, chat, video conference) by which a consumer 120 can be connected to the provider 130. Alternatively, the tracking module 114 determines (208) the capabilities of the terminals 122 and 132 the consumer 120 and the provider 130 use to connect to the system (for example, by using a terminal-based program to analyze the hardware configuration of each terminal). Thus, if a provider 130 connects to the system 100 by a desktop computer and the provider has a video camera connected to that computer, the tracking module 112 determines that the provider 130 can be engaged by text (e.g., chat or instant messenger), voice (e.g., VoIP) or video conference. Similarly, if a provider 130 connects to the system using a handheld device such as a PDA, the tracking module 112 determines (210) that the provider 130 can be engaged by text or voice. The tracking module 112 can also infer a provider's availability and modes of engagement by the provider's previously provided profile information and the terminal device through which the provider connects to the system.

The tracking module 112 transfers (212) information about the availability and the communication capability of the consumers 120 and the providers 130 to the scheduling module 116 using, for example, one or more well-known presence protocols, such as Instant Messaging and Presence Service (IMPS), Session Initiation Protocol (SIP) for Instant Messaging and Presence Leveraging Extensions (SIMPLE), and the Extensible Messaging and Presence Protocol (XMPP).

One advantage that the brokerage provides is that the brokerage constantly monitors the availability of a provider for an engagement through a reverse provider practice. In order to achieve such a level of availability, the system assimilates the discretionary or fractional availability windows of time offered by individual providers into a continuous availability perception by consumers. Because many of the services offered to consumers are on-demand, consumers have little expectation that the same provider will be constantly available. However, consumers have an expectation that some provider will be available. As discussed in further detail below, the brokerage system supports a large number of available providers and therefore the system provides tools (e.g., navigational components, links and selection boxes) to assist a consumer in selecting an appropriate provider. In an example, the system promotes searching for service providers by generating a graphical user interface with input elements, including, e.g., text boxes, search boxes, dropdown menus, and so forth.

The computerized system 110 provides information and services to the consumers 120 in addition to connecting them with providers 130. The computerized system 110 includes an access control facility 114, which manages and controls whether a given consumer 120 accesses the system 110 and what level or scope of access to the features, functions, and services the system 110 will provide.

The consumer 120 uses the system 100 to find out more information about a topic of interest. The computerized system 110 identifies service providers 130 that are available at any given moment to communicate with a consumer about a particular type of content. The computerized system 110 facilitates communication between the consumer 120 and provider 130, enabling them to communicate, for example, via a data-network-facilitated video or voice communication channel (such as Voice over IP), land and mobile telephone network channels, and instant messaging or chat. The availability of one or more providers 130 is tracked, and at the instant a consumer 120 desires to connect and engage in a consultation with a provider (e.g., via live video and/or audio,) the system 110 determines whether a provider is available. If a particular provider 130 is available, the system 110 assesses the various modes of communication that are available (e.g., based on common modes and modes preferred by the provider) and connects the consumer 120 and the provider 130 through one or more of the common modes of communication.

In addition, the system selects a mode of communication to use based in part on the relative utility of the various modes. The preferred mode for an engagement is for both the consumer 120 and the provider 130 to use web-based consoles, as this allows each of the other modes to be used as needed. For example, consumers and providers launch chat sessions, voice calls, or video chats from within a web-based console. If the provider 130 is not available, the system 110 identifies other available providers 130 that would meet the consumer's needs. The system 110 enables the consumer 120 to send a message to the consumer's chosen provider. The consumer can also have the system 110 contact the consumer in the future when the chosen provider is available.

Providers participating in the brokerage network can have several states of availability over time. States in which the provider are available include on-line, in which the provider is logged-in and can accept new engagements in any mode, on-line (busy), in which the provider is logged-in but is currently occupied in a video or telephonic engagement, and scheduled, in which the provider is offline but is scheduled to be online at a designated time-point and can pre-schedule engagements for it. While not online, the provider can take messages as in offline state. Other states include off-line, in which the provider is not logged in but can take message-based engagements (i.e., asynchronous engagements), out-of-office, in which the provider is not accepting engagements or messages, and standby, in which the provider is offline and can be paged to Online status by the brokerage network if traffic load demands it (in some examples, consumers see this state as offline).

The operating business model for the provider network employs a remuneration scheme for providers that helps assure that the consumers can find providers in designated professional domains in the online mode. For example, selected providers can be remunerated for being in the standby mode to encourage their on-line availability in case of low discretionary availability by other—providers in their professional domain. Standby providers are also called into the on-line state when the percentage of on-line (busy) providers in their professional domain exceeds a certain threshold of all providers currently on-line (busy and standby). In some examples, the transition of providers from standby to online and back to standby (in case of over capacity or idle capacity) is an automated function of the system.

As noted, the system 100 includes access control facilities 114 that control how consumers 120 access the system and to what extent or level the services provided by the system are made available to consumers. The system 100 also stores and provides access to consumer information (e.g., contact information, and preference/profile information to be described later). However, other consumer information would typically be not accessible to the service provider, such as credit rating information, financial information, and credit card information. Similarly, provider information (e.g., biographies, product and service information, and any information the provider wants to make available to consumers) can be made available. The access control facility 114 would prevent unauthorized access to this information.

The brokerage provides compensation for products and services provided. Access to the system 100 is provided on a subscription basis, with consumers paying a fee (either directly or indirectly through another party) to be provided with a particular level of access to the system. In exchange for providing products or services, the service provider receives compensation from the consumer. In one embodiment, the consumer pays the operator, which keeps a portion (e.g., a percentage payment or a flat fee) and pays the remainder to the service provider. In another embodiment, the consumer or the service provider pays a flat fee or percentage of the fee for the engagement to the operator. The operator is paid a flat fee or a percentage of the fee for the engagement transaction. Alternatively, the consumer or the service provider or both pays a fee (a service fee) to the operator for providing the connection. The brokerage allows consumers to engage provider's “on demand” based on provider availability. Engagements can be established in various ways, including the following.

Asynchronous correspondence—The lowest level of true provider interaction is by way of secure messaging. The question or topic of the engagement is sent to a selected provider (whether online or not) and can be answered by this provider at her leisure. Turnaround times are monitored by the system and are part of the credentials of the provider used for her selection by consumers. The system informs the consumer once a response has been received and can allow the consumer to redirect the question if he needs more urgent response time. For example, typical types of asynchronous correspondence include e-mail, instant messaging, text-messaging, voice mail messaging, VoIP messaging (i.e., leaving a message using VoIP), and paper letters (e.g., via the U.S. Postal Service).

Synchronous correspondence—Several forms of synchronous correspondence allow the consumer and the provider to engage in real-time discussions.

Synchronous text correspondence—This is referred to as a “Chat” module where both sides of the engagement type their entries in response to each others' entries. The form of communication is text based but is still a live communication. Examples include instant messaging and SMS messaging.

Web-based streaming live video—The use of broadband network connections allows for real-time voice and video transmission over the Internet. Web-based teleconferencing uses VoIP, SIP, and other standard or proprietary technologies. Small digital cameras, referred to as webcams, attached to or built in to personal computers or laptops can he used for this purpose and can be provided by standard software or by custom software provided by the brokerage. Alternatively, dedicated video conferencing communication equipment or telephones with built-in video capabilities can be used.

Telephonic conferencing—Consumers who wish for a direct telephonic communication with a provider or who are not comfortable using their computer use a traditional telephone for interaction with a provider. The consumer uses a dial-in number and an access code that connects him to the brokerage's servers. Providers are linked to the servers via VoIP, other data-network-based voice systems, or their own telephones. Telephonic conferencing also allows consumers to request “call me now” functions, in which the provider calls the consumer (directly or through the brokerage).

In some examples, a consumer redirects an active engagement to another provider or provider type. A consumer redirects an engagement to employ a different mode of communication with the current provider (e.g., move front a text chat to a phone conversation).

Service providers are the individuals responding to consumers queries and participating in engagements and streaming live video/audio over the network. Providers agree to the terms of the brokerage, such as payment for their time in performing engagements, the protocol of conduct desired, and the ramification and distribution of liability in case of violations of that protocol.

Prior to joining the brokerage network, a provider establishes a profile that that is searchable by consumers. The profile is used for several purposes, including determining the relative cost of the provider's time to either the consumer or the brokerage sponsor, and providing consumers with information that is relevant to their choice to engage one provider versus another. The provider's profile is used to allow a provider (e.g., a celebrity) to establish a forum in which consumers (e.g., fans) bid for the provider's time. In one particular example, a celebrity Wants to auctions a predefined period of time (e.g., ten minutes) in which the celebrity engages in a consultation (e.g., a discussion) with a consumer and sends the proceeds of the consultation to a charity.

Some information about the provider is verified by the brokerage (e.g., Tax ID, education, professional certification, demographics, and contact information), and some is acquired during the provider's participation on the brokerage. Such data includes length of service, number of engagements, consumer satisfaction, projected availability, etc. A provider also provides a general introductory note, a picture, and voice and video welcome snippets. Providers also add other information they deem relevant for consumers (e.g., a list of publications and honorary appointments). Individual service providers are also able to register and enroll with the system. Individual service providers are independent service providers not affiliated with a provider network. As part of the provider selection process described above, consumers benefit from access to introductory material from the provider. As consumers search for providers to meet their needs, they can select to view only providers where such material is available, producing an incentive for providers to take advantage of such capability.

Providers interact with consumers through a provider console web page. This interface is similar to that used by the consumers. The provider console provides access to the various tools used by providers. A window shows a live image of the consumer, with tools to control or disable the video feed. A phone control allows the provider to initiate a phone call with the consumer. A log of an ongoing chat is displayed above an input for the provider's next comment. Other tools are available in tabs on the side, such as accesses to the terms of operation and the legal policies of the brokerage, such as disclaimers. State setting allows the providers to change his availability state between states such as off-line, on-line and out-of-office. Scheduling allows providers to update their availability calendar with future times they expect to be available on the system, which can in turn result in consumers seeing a “scheduled” state for such providers.

Messaging tools allow providers to correspond with consumers in message-based engagements. The console also allows the provider to participate in chat engagements where the consumer and the provider communicate back-and-forth in real-time by typing. The brokerage allows a single provider to engage in more than one chat at a time to maximize his yield while consumers are typing their entries. The chat feature also allows the provider to forward specific lists of questions to further reduce the need for his time in acquiring information from the consumer at the beginning of an engagement. Tools available to assist the provider in chat or messaging include a thread viewer, the consumer's engagement history, a communication timeline chart, and a library of built-in and self-produced message templates for quick response, and a knowledgebase for sales and support agents (e.g., when the system is used in private operator mode). Such templates also include references, links, and embedded graphical educational content on prevalent topics. In some examples, the brokerage scans outbound messages for inappropriate language based on the sponsor's preferences.

The console allows the provider to hold a voice conference engagement with the consumer when the consumer is using either her computer or a telephone. The provider can use the console to redirect his end of the conference to a phone, for example, if bandwidth or other considerations indicate it or simply based on personal preference. The console also allows the provider to engage in video conferences with consumers. Audio is served via the console or is redirected to a telephone. To verify a provider's identity when using the telephone for a voice engagement, the system provides the provider with a PIN number through the provider console. When the provider calls into the system, or answers the phone when called by the system, the provider enters the PIN to confirm that the person on the phone is the same person who is logged into the console. This method is also used to leave secure voice message. When a provider wants to leave a message for a consumer, the provider requests permission from the console to leave a message and receives a PIN that allows the provider to leave the message. The provider receives a call from the system, enters the PIN, and leaves the message. The message is delivered to the consumer. The use of the PIN provides an assurance that the message was left by the provider.

The provider is able to review his account status, system settings, and preferences. The provider can also access his profile and user satisfaction and statistics as they are available to consumers. The console also connects to financial services associated with the provider's participation in the brokerage. This includes status of charges. The brokerage offers providers the ability to redirect messages or requests for appointment to SMS-compatible cellular phones. In this mode, the provider associates a cell phone number with his account and establishes the type of information that the system can send to the mobile device. Such information includes engagement-related notifications as well as system-related notifications (e.g., an announcement about a high-traffic state asking providers to make themselves available and offering a higher fee to do so).

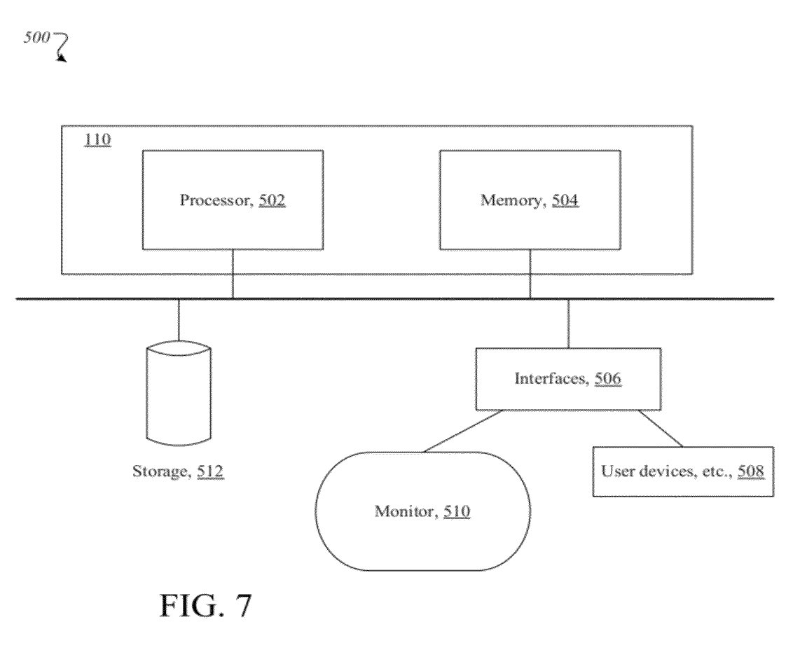

FIG. 7 is a block diagram of components 500 of the engagement brokerage system. User devices 508 can be any sort of computing device capable of taking input from a user and communicating over a network (not shown) with server 110 and/or with other client devices. For example, user device 508 can be a mobile device, a desktop computer, a laptop, a cell phone, a personal digital assistant (“PDA”), a server, an embedded computing system, a mobile device and so forth. User devices 508 include monitor 510 which render visual representations of interface 506.

Server 110 can be any of a variety of computing devices capable of receiving information, such as a server, a distributed computing system, a desktop computer, a laptop, a cell phone, a rack-mounted server, and so forth. Server 110 may he a single server or a group of servers that are at a same location or at different locations.

Server 110 can receive information from client device user device 508 via interfaces 506, including, e.g., graphical user interfaces. Interfaces 506 can be any type of interface capable of receiving information over a network, such as an Ethernet interface, a wireless networking interface, a fiber-optic networking interface, a modem, and so forth. Server 110 also includes a processor 502 and memory 504. A bus system (not shown), including, for example, a data bus and a motherboard, can be used to establish and to control data communication between the components of server 110.

Processor 502 may include one or more microprocessors. Generally, processor 502 may include any appropriate processor and/or logic that is capable of receiving and storing data, and of communicating over a network (not shown). Memory 504 can include a hard drive and a random access memory storage device, such as a dynamic random access memory, machine-readable media, or other types of non-transitory machine-readable storage devices.

Components 500 also include storage device 512, Which is configured to store information collected through the brokerage system during a service provider's consultation with a consumer.

Embodiments can be implemented in digital electronic circuitry, or in computer hardware, firmware, software, or in combinations thereof. Apparatus of the invention can be implemented in a computer program product tangibly embodied or stored in a machine-readable, storage device and/or machine readable media for execution by a programmable processor; and method actions can be performed by a programmable processor executing a program of instructions to perform functions and operations of the invention by operating on input data and generating output. The invention can be implemented advantageously in one or more computer programs that are executable on a programmable system including at least one programmable processor coupled to receive data and instructions from, and to transmit data and instructions to, a data storage system, at least one input device, and at least one output device. Each computer program can be implemented in a high-level procedural or object oriented programming language, or in assembly or machine language if desired; and in any case, the language can be a compiled or interpreted language.

Suitable processors include, by way of example, both general and special purpose microprocessors. Generally, a processor will receive instructions and data from a read-only memory and/or a random access memory. Generally, a computer will include one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD_ROM disks. Any of the foregoing can be supplemented by, or incorporated in, ASICs (application-specific integrated circuits).

Other embodiments are within the scope and spirit of the described claims. In an example, the brokerage services described herein may be applied to numerous, different types of service providers, including, e.g., medical professionals, physicians, nurses, and so forth. In another example, due to the nature of software, functions described above can be implemented using software, hardware, firmware, hardwiring, or combinations of any of these. Features implementing functions may also be physically located at various positions, including being distributed such that portions of functions are implemented at different physical locations.

What is claimed is:

1. A computer-implemented method comprises:
receiving, by one or more computer systems, a request sent from a computing device used by a consumer, the request being to find a service provider;
determining whether the consumer that sent the request is associated with a sponsor; when associated with a sponsor,
retrieving, by the one or more computer systems, a listing of types of services offered by the. sponsor;
sending, by the one or more computer systems to the computing device, a list of one or more qualified service providers that are qualified to provide a type of service selected from the listing;
receiving, by the one or more computer systems, a selection of a service provider from the list; and
establishing a communication channel between the computing device used by the consumer and a computing device used by the selected service provider.

2. The computer-implemented method of claim 1 further comprising:
identifying, by the one or more computer systems, at least one of the one or more qualified service providers as being presently available to engage in a consultation with the consumer.

3. The computer-implemented method of claim 1 further comprising:
generating a graphical user interface to send to the computing device used by the consumer, the graphical user interface rendering the listing of types of services.

4. The computer-implemented method of claim 1, further comprising:
receiving information indicative of a change in the types of services offered by the sponsor.

5. The computer-implemented method of claim 1, further comprising:
tracking selections of the types of services offered;
analyzing tracked selections of the types of services offered providing statistical analysis of the selections by consumers; and
modifying the types of services offered based on the Statistical analysis made of the selections.

6. The computer-implemented method of claim 3, further comprising:
receiving, from the computing device used by the consumer, a selection of one of the types of services; and
causing the graphical user interface to be updated with visual representations of the one or more service providers qualified to provide the selected type of service.

7. The computer-implemented method of claim 6, wherein one or more of the visual representations are juxtaposed to one or more status indicators indicative of a status of a service provider.

8. One or more machine-readable media configured to store instructions that are executable by one or more processing devices to perform operations comprising:
receiving a request sent from a computing device used by a consumer, the request being to find a service provider;
determining whether the consumer that sent the request is associated with a sponsor; when associated with a sponsor,
retrieving a listing of types of services offered by the sponsor;
sending, to the computing device, a list of one or more qualified service providers that are qualified to provide a type of service selected from the listing;
receiving a selection of a service provider from the list; and
establishing a communication channel between the computing device used by the consumer and a computing device used by the selected service provider.

9. The one or more machine-readable media of claim 8, wherein the operations further comprise:
identifying at least one of the one or more qualified service providers as being presently available to engage in a consultation with the consumer.

10. The one or more machine-readable media of claim 8, Wherein the operations further comprise:
generating a graphical user interface to send to the computing device used by the consumer, the graphical user interface rendering the listing of types of services.

11. The one or more machine-readable media of claim 8, wherein the operations further comprise:
receiving information indicative of a change in the types of services offered by the sponsor.

12. The one or more machine-readable media of claim 8, wherein the operations further comprise:
tracking selections of the types of services offered;
analyzing tracked selections of the types of services offered providing statistical analysis of the selections by consumers; and
modifying the types of services offered based on the statistical analysis made of the selections.

13. The one or more machine-readable media of claim 10, wherein the operations further comprise:
receiving, from the computing device used by the consumer, a selection of one of the types of services; and
causing the graphical user interface to be updated with visual representations of the one or more service providers qualified to provide the selected type of service.

14. An electronic system comprising:
one or more processing devices; an
one or more machine-readable media configured to store instructions that are executable by the one or more processing devices to perform operations comprising:
receiving a request sent from a computing device used by a consumer, the request being to find a service provider;
determining whether the consumer that sent the request is associated with a sponsor; when associated with a sponsor,
retrieving a listing of types of services offered by the sponsor;
sending, to the computing device, a list of one or more qualified service providers that are qualified to provide a type of service selected from the listing;
receiving a selection of a service provider from the list; and
establishing a communication channel between the computing device used by the consumer and a computing device used by the selected service provider.

15. The electronic system of claim 14, wherein the operations further comprise:
identifying at least one of the one or more qualified service providers as being presently available to engage in a consultation with the consumer.

16. The electronic system of claim 14, wherein the operations further comprise:
generating a graphical user interface to send to the computing device used by the consumer, the graphical user interface rendering the listing of types of services.

17. The electronic system of claim 14, wherein the operations further comprise:
receiving information indicative of a change in the types of services offered by the sponsor.

18. The electronic system of claim 14, wherein the operations further comprise:
tracking selections of the types of services offered;
analyzing tracked selections of the types of services offered providing statistical analysis of the selections by consumers; and
modifying the types of services offered based on the statistical analysis made of the selections.

19. The electronic system of claim 16, wherein the operations further comprise:
receiving, from the computing device used by the consumer, a selection of one of the types of services; and
causing the graphical user interface to be updated with visual representations of the one or more service providers qualified to provide the selected type of service.

20. The electronic system of claim 19, wherein one or more of the visual representations are juxtaposed to one or more status indicators indicative of a status of a service provider.
